(19) United States
(12) Patent Application Publication
(10) Pub. No.: US 2023/0187636 A1
(43) Pub. Date: Jun. 15, 2023

(54) METHOD FOR PRODUCING AN ELECTRODE WITH HETEROGENEOUS MULTIPLE COATING

(71) Applicant: BATTRION AG, Dübendorf (CH)

(72) Inventors: Max KORY, Zurich (CH); Eric WILLIAMS, Zurich (CH)

(73) Assignee: BATTRION AG, Dübendorf (CH)

(21) Appl. No.: 18/065,004

(22) Filed: Dec. 13, 2022

(30) Foreign Application Priority Data
Dec. 14, 2021 (DE) 10 2021 133 008.4

(51) Int. Cl. H01M 4/583; H01M 10/0525; H01M 4/04; H01M 4/62

(52) U.S. Cl. CPC H01M 4/583; H01M 10/0525; H01M 4/0404; H01M 4/622; H01M 4/624; H01M 2004/027

(57) ABSTRACT

A quality-improving method is proposed for producing an electrode, e.g. a negative electrode for lithium-ion batteries, comprising providing a carrier in the form of a foil, coating the carrier with a first coating material on at least one of the two sides of the carrier on the carrier surface, to give an adhesion layer, coating the carrier with a second coating material on the first coating material, so that the first and second coating materials each form a layered arrangement composed of a first layer of the first coating material and a second layer of the second coating material on the carrier, where the first and second coating materials used are different materials.

This application claims the benefit under 35 USC § 119(a)-(d) of German Application No. 10 2021 133 008.4 filed Dec. 14, 2021, the entirety of which is incorporated herein by reference.

### FIELD OF THE INVENTION

The present invention relates to a method for producing an electrode, more particularly, a negative electrode, for lithium-ion batteries, and also to such an electrode and to a battery cell.

### BACKGROUND OF THE INVENTION

WO 2019/166 899 A1 from the prior art discloses a method enabling production of negative electrodes for lithium-ion batteries, by coating a copper carrier foil with a paste containing graphite particles. These particles are oriented in a temporally and/or locally mutative magnetic field to shorten the distances the ions have to travel during charging/discharging, with possible resultant advantages such as reduced cell resistance and higher discharge rates, a shorter charge time or reduction in heat given off by the cells. With conventional electrodes, however, it is possible in certain cases for the local contact resistance between coating and copper foil to be surprising high.

### SUMMARY OF THE INVENTION

It is an object of the present invention conversely to provide a method which allows the production of electrodes with improved quality but without performance loss.

In the production of such electrodes, for example, the carrier foils are coated generally with a layer of a suspension which as well as graphite particles includes carboxymethylcellulose (CMC) and a styrene-butadiene rubber (SBR binder). CMC is a surface modifier which allows effective dispersing of the particles in water but which also modifies the rheology and so enables a paste of stable viscosity to form, that can be applied optimally to the foil without bubbles, but does not allow sedimentation. The SBR binder ensures adhesion and elasticity of the coating. In certain cases, especially when silicon/silicon oxide-containing negative electrodes are used, a polyacrylic acid-based binder system may also be employed. The particles are subsequently aligned, generally in a temporally and/or locally mutative magnetic field. After the alignment, or often even during the alignment, a drying process begins, for drying and fixing the layers on the carrier foil. The coated carriers, finally, are rolled. The present patent application is concerned here essentially with a coating operation of this kind for the coating of the carrier foil.

For the specific application of a lithium-ion battery (or lithium-ion storage battery), for example, the anode comprises a graphite layer into which lithium ions undergo intercalation. During discharging, this assembly gives up electrons, which flow to the cathode via the external current circuit to be fed through the cell. At the same time, lithium cations from the intercalation layer move through the electrolyte of the cell to the cathode. In order to be able to recharge the storage battery later, the operation is reversed, and so the lithium cations have to move from the cathode back in the direction of the anode. The layered structure of the graphite used is composed of graphite particles, often present in platelet form. Following the application of the graphite layers, there is usually a parallel alignment of the graphite particles to the surface on which they have been applied. As the lithium cations move through this layer, the lithium ions have to travel around these platelets, so leading to tortuous pore channels and to comparatively long pathways on diffusion of the lithium ions.

With the method of the present invention, accordingly, the initial starting point is a carrier in the form of a carrier foil. This may, for example, be a copper foil. According to the present invention, this foil is provided with a multiple coating comprising at least two layers. The flat, foil-like carrier is coated at least on one side of the two sides. More particularly, the layers are applied separately—that is, there is no application of a layer which splits into, for example, two or more phases only as a result of subsequent treatment after the coating process.

The first layer, applied directly on the carrier surface, consists of a first coating material and has functions including that of an adhesion layer. It is, therefore, possible to prevent the coating inadvertently detaching. In addition, a consistently low contact resistance between carrier foil and coating is enabled. The second layer, which is applied in turn on the first layer, consists of a second coating material. It may, for example, critically determine the ionic resistance.

The quality of the electrodes to be produced can be improved, consequently, because of the marked reduction in the likelihood of detachment of the coating.

Depending on specific application, the multiple coating may also comprise more than two layers, allowing the ionic resistance of the electrode to be optimized, in particular. With preference three layers may be provided, and may be configured in such a way that the adhesion properties with respect to the carrier foil increase gradually, while the ionic flow to the side remote from the carrier becomes higher and is improved.

In one exemplary embodiment, for instance, it is conceivable for the first layer applied to be an adhesion layer, which has no paste comprising graphite particles, instead comprising initially a dispersion, more particularly, a polymer dispersion, which can be used as a bonding layer, for advantageously providing the coating with particular stability.

A layer, more particularly, the layer envisaged as an adhesion layer and applied in the form of a (polymer) dispersion, may preferably further comprise conductive carbon black or other additives for increasing the conductivity as well.

At least one of the coating materials may take the form of a paste comprising particles, more particularly graphite particles, and the particles may be aligned for improved conduction of the ions. Two or more coating materials composed of a paste with particles may already differ in that the particles in the respective layers have a different shape or size and/or a different volume on average by comparison with one another.

Hence in one variant embodiment (even without a polymer-based adhesive), the adhesion in the first layer, applied directly on the carrier, may already be improved in that this layer contains spherical particles or optionally these particles at least on average are more spherical than the particles of the mixed layer located above it. To be expected in particular is that a layer composed of a paste comprising flakelike particles oriented perpendicularly to the carrier surface is not so resistant and stable in its adhesion as a layer comprising spherical particles, because spherical particles offer a larger contact area. Flakelike particles have a more strongly anionotropic shape than spherical particles. The particles in the layer over the adhesion layer composed of spherical particles may, for example, be flakelike in configuration and may be oriented later in a locally or temporally mutative magnetic field in order to shorten the distances traveled by the flowing ions.

If it is important, in one embodiment of the present invention, to minimize the cell resistance by means of a first adhesion layer as well, then this layer may also contain flakelike particles on the carrier surface. The layers differ, for example, in the size and/or volume of the flakelike particles. Because of the larger particles contained therein, therefore, the top layer or top layers also have a greater pore volume. Moreover, polarization effects can be prevented (less lithium plating). More rapid charging of the cell is enabled as well. The particles in the individual layers may additionally have different alignments. Depending on their size, the effectiveness in the context of the alignment of the particles in the magnetic field may change, thus producing, in terms of the particle alignment, an anisotropy of the layers comprising particles of different sizes.

Depending on variant embodiment, accordingly, distinguishing features between the layers may be as follows:

shape of the particles, in particular spherical through to flakelike, and/or

the size and/or volume of the particles, and/or

the alignment of the particles.

The adhesion may be influenced by the size of the particles, since smaller particles are generally associated with an increase in the contact area. Instead, an increase in the adhesion may in turn be achieved by using a polymer dispersion as adhesive.

There may be a tradeoff between the use of spherical particles with greater adhesion effect and particles having good conduction properties for conducting the ions in that the layer in contact with the carrier may be provided with flakelike particles which, however, are smaller or have a smaller volume than the flakelike particles in the layer located above it:

on the one hand, in the case of aligned flakes, especially in the case of an alignment perpendicular to the carrier surface, the distance traveled by the ions through the layer is reduced and hence the cell resistance is reduced, the charge time is shortened, the discharge power is increased, and the heat given off is reduced.

On the other hand, smaller particles can, in principle, be packed more closely and enable a larger contact area with greater adhesion.

In one particularly preferred development of the present invention, the carrier is coated with at least three layers, and more preferably at least one of the layers takes the form of an adhesion layer. For this purpose, the adhesion layer may be configured either as a polymer dispersion having bonding properties, or a paste is used comprising particles, thus having an active material, where the particles are smaller than in another layer composed of a paste comprising particles and/or are spherical in form, so that they are arranged more closely packed and/or form a larger contact area. In order to be able to prevent detachment directly from the carrier, the adhesion layer may be located directly on the carrier. Alternatively, it is conceivable for an adhesion layer, with or without particles, to be arranged between two layers with active material, in order to produce a layered construction with a greater level of stability.

For the purpose of increasing the conductivity, advantageously, a layer, more particularly of a particle-comprising paste, may be admixed with an admixture composed of conductive material, such as conductive granules, more preferably of conductive fibers or carbon nanotubes. Immediately above the carrier foil, such an admixture for increasing the conductivity may be omitted. This first layer may have a thickness in the region of a few micrometers, more particularly about 1 μm.

In the coating process, the layers in the case of one embodiment of the present invention may in principle be applied sequentially. Since the paste is applied per layer but is only dried later during and/or after the alignment of the particles, the layer already applied may be distorted at the upper interface in the case of sequential application. This distortion effect may at least be reduced if the layers are applied simultaneously. This can be done using a nozzle which has a plurality of channels in succession in the direction of application, so that the channel which is first in the direction of application applies the bottommost layer, the subsequent channel the layer lying above it, and so on. As a result of the temporally parallel application it is also possible to shorter the production time.

The advantages of the present invention can be utilized in a corresponding electrode or cell.

### BRIEF DESCRIPTION OF THE DRAWINGS

Exemplary embodiments of the present invention are represented in the drawings and are elucidated in more detail below with indication of further details and advantages.

FIG. 1 shows an electrode with a carrier coated with layers of particles of different sizes;

FIG. 2 shows an electrode with a carrier coated with flakelike particles of different shapes;

FIG. 3 shows a schematic representation of the coating of a carrier with a nozzle for temporally parallel application of the layers; and

FIG. 4 shows a schematic representation of an electrode with carrier and a coating composed of three layers.

### DETAILED DESCRIPTION OF THE INVENTION

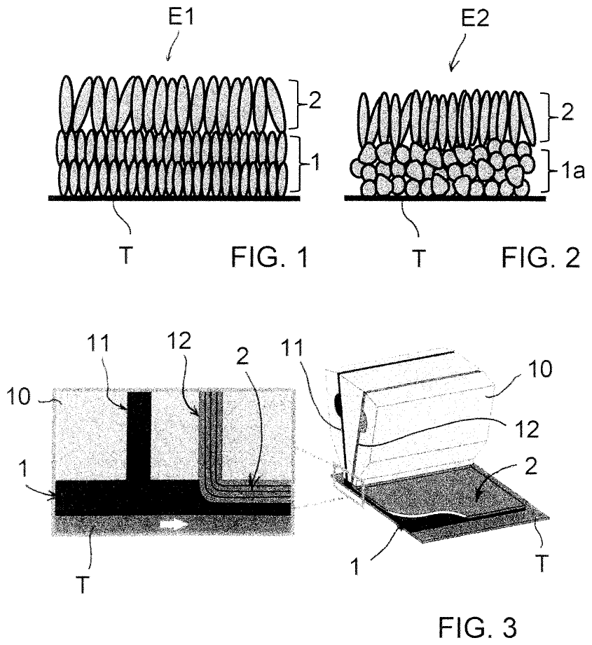

FIG. 1 shows an electrode El, comprising a carrier T with a first layer 1, which contains small flakelike particles, and with a second layer 2, which contains larger flakelike particles; more specifically, in other words, the particles of the first layer 1 are nevertheless smaller on average than the flakelike particles in the second layer 2 above it. The particles in the two layers 1 and 2 are oriented substantially perpendicularly to the surface, the alignment of the particles being performed only after the respective application in a temporally and/or locally mutative magnetic field. The smaller particles of the first layer 1 can, in principle, be packed more closely than the larger particles in layer 2 and may, therefore, also offer a greater contact area. The first layer 1 on the carrier surface serves as an adhesion layer and enables a greater stability. As a result of the relatively uniform, perpendicular orientation of the particles in the layers 1 and 2, the ions are able to flow past the particles on an approximately linear path. The cell resistance, accordingly, is low, high powers are enabled during discharge of the battery, and the accompanying heat given off is low. Moreover, the charging process can be accelerated.

The embodiment of the electrode E2 according to FIG. 2 differs, in particular, from the exemplary embodiment of the electrode E1 according to FIG. 1 in that, rather than a first layer 1 with flakelike particles, a first layer la with spherical particles is provided. In comparison to the embodiment according to FIG. 1, the spherical particles provide a larger contact area than the flakelike particles in the first layer from FIG. 1. For ion conduction, a higher resistance is likely in layer la in FIG. 1.

The layers 1 and 2 or 1a and 2 may be applied by means of a specific nozzle 10, as also represented in FIG. 3. The channels 11 and 12 are arranged in parallel and consecutively in the direction R of application. The leading channel 11 applies the layer 1 or 1a applied directly on the carrier surface. The next, subsequent channel 12 forms the overlying layer 2, and so on. A comparatively rapid application is enabled, in which also the formation of bubbles can be reduced.

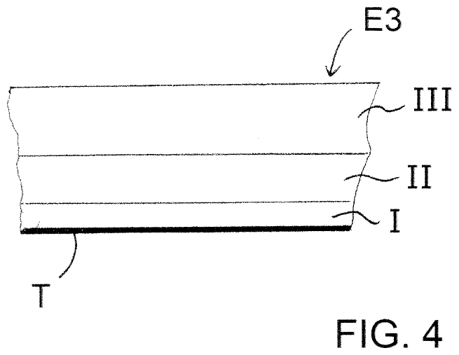

FIG. 4 in turn shows a general representation of an electrode E3 having three layers I, II and III, applied on the carrier T. The layers I, II and III may be applied with a nozzle corresponding, in principle, to the nozzle 10 in its construction, but instead having three channels.

The first layer I on the carrier T has the function of an adhesion layer. The two layers II and III above it possess graphite particles, the sizes of which increase in average from layer I to layer III. The pore structure is improved, with increasingly larger pores as the distance from the carrier goes up. The ion flow as well can be channeled more effectively in this way. Layer II comprises spherical particles, which by virtue of the large contact area are also able to make a large contribution to the adhesion. Arranged in the third layer III above, in turn, are flakelike particles, which have been oriented substantially perpendicularly to the surface of the carrier T. An embodiment of this kind is able to offer a particularly stable construction.

In a further variant embodiment of the present invention, the first layer I may instead be configured as a layer comprising active material, hence possessing graphite particles. In order to obtain good adhesion properties, the graphite particles of the first layer I may, for example, be small and spherical, thus affording a large contact area and hence an effective hold. Conductive carbon nanotubes may be integrated in this layer, for example, according to the adaptation of the conductivity properties.

Furthermore, a further layer II may have been applied, comprising flakelike particles, or an adhesion layer composed of a polymer dispersion, for example, while large, flakelike particles are arranged in turn as a third layer III. The alignment of the flakelike particles shortens the distance the ions must travel during charging or discharging, with possible advantageous consequences for the performance of a battery, for the charge time, and for a reduction in the heat produced.

Frequently, however, pastes with particles are used that also comprise nanotubes or other conductive material. In this case, in one embodiment, at least two layers possess the same concentration of conductive material.

### LIST OF REFERENCE SYMBOLS

1 first layer (small, flakelike particles)
1a first layer (spherical particles)
I first layer
2 second layer (flakelike particles)
II second layer
III third layer
10 nozzle
11 leading channel
12 trailing channel
E1 electrode
E2 electrode
E3 electrode
T carrier

1. A method for producing a negative electrode for lithium-ion batteries, comprising:
providing a carrier in the form of a foil,
coating the carrier with a first coating material on at least one of the two sides of the carrier directly on the carrier surface,
coating the carrier with a second coating material, which is applied on the first coating material,
so that the first and second coating materials each form a layered arrangement composed of a first layer of the first coating material and of a second layer of the second coating material on the carrier,
wherein first and second coating materials used are different materials.

2. The method according to claim 1, wherein the carrier is coated with at least one further, nth coating material, which is applied respectively to the topmost, (n−1)th coating material on the carrier, wherein n≥3 is a natural number.

3. The method according to claim 1, the carrier is coated with at least three coating materials, which are each applied as layers lying one above another.

4. The method according to claim 1, wherein at least one of the coating materials used is:
a paste, which comprises graphite particles, and/or
a polymer dispersion, which serves preferably as a bonding and/or adhesion layer, and/or
a mixture of a paste, which comprises graphite particles and a polymer dispersion, which serves preferably as a bonding and/or adhesion layer.

5. The method according to claim 1, wherein at least two of the coating materials used are pastes respectively comprising particles and differing from one another in that:
the shape of the particles is different from layer to layer and/or
the size and/or the volume of the particles are/is different from layer to layer.

6. The method according to claim 1, wherein the first coating material applied is one comprising spherical particles, to increase the adhesion to the carrier, and the second coating material applied is one with nonspherical shape.

7. The method according to claim 1, wherein the first coating material used is a material whose particles are smaller than those of the second coating material, and the coating materials applied are each materials comprising particles of anisotropic shape.

8. The method according to claim 1, wherein an alignment of the particles is carried out in a locally and/or temporally mutative magnetic field after the coating of the carrier with the at least two coating materials.

9. The method according to claim 1, wherein a layer comprising an electrically conductive material composed of fibers or of granular material is applied directly on the carrier, and, directly or indirectly over it, a further layer is applied of a different coating material comprising the same concentration of electrically conductive material composed of fibers or of granular material.

10. The method according to claim 1, wherein the carrier is coated simultaneously with all the coating materials or in that the respective layers are applied sequentially.

11. The method according to claim 2, wherein coating takes place using a nozzle which provides at least one channel for each layer to be applied, for conducting and for applying the coating materials, wherein the channels are arranged consecutively in relation to the application direction and/or the longitudinal direction of the carrier, wherein the channel for the first layer is arranged upstream, in application direction, of the channel for the second layer and the latter channel is arranged, if at least three coatings are envisaged, upstream of the channel for the nth layer, wherein n≥3 is a natural number.

12. An electrode obtainable by the method according to claim 1.

13. A negative electrode for lithium-ion batteries, comprising:
a carrier,
bearing a first layer comprising a first coating material, applied on at least one of the two sides of the carrier directly on the carrier surface,
wherein the first layer bears an applied second layer comprising a second coating material,
wherein the first coating material differs from the second coating material.

14. The electrode according to claim 13, wherein the carrier is coated with at least one further, nth coating material, which is applied respectively to the topmost, (n−1)th coating material on the carrier, wherein n≥3 is a natural number.

15. The electrode according to claim 13, wherein the carrier is coated with at least three coating materials which are applied as layers one over another.

16. The electrode according to claim 13, wherein at least one of the coating materials takes the form of:
a paste which comprises graphite particles, and/or
a polymer dispersion for forming a bonding and/or adhesion layer, and/or
a mixture of a paste which comprises graphite particles and a polymer dispersion, which takes the form of a bonding and/or adhesion layer.

17. The electrode according to claim 13, wherein a layer comprising an electrically conductive material composed of fibers or of granular material is applied directly on the carrier, and, directly or indirectly over it, a further layer is applied of a different coating material comprising the same concentration of electrically conductive material composed of fibers or of granular material.

18. The electrode according to claim 13, wherein at least two of the coating materials take the form of pastes which comprise particles and which differ from one another wherein:
in the first layer closer to the carrier, more spherical particles are provided than in the second layer, and spherical particles are provided in the first layer as an adhesion layer and flakelike particles are provided in the second layer, and/or
in the first layer, smaller particles are provided than in the second layer and/or wherein the particles of the first and second layers are flakelike in form, and/or
the alignment of the particles is different from layer to layer and the respective layers have particles of anisotropic shape in order to be able to reduce polarization effects.

19. The electrode according to claim 18, wherein the flakelike particles are aligned substantially and/or predominantly and/or completely in at least one of the layers perpendicularly to the carrier surface.

20. A battery cell comprising an electrode according to claim 12.
